(19) United States
(12) Patent Application Publication
(10) Pub. No.: US 2022/0335086 A1
(43) Pub. Date: Oct. 20, 2022

(54) FULL-TEXT INDEXING METHOD AND SYSTEM BASED ON GRAPH DATABASE

(71) Applicant: Vesoft Inc., Hangzhou (CN)

(72) Inventors: Bosheng CHEN, Hangzhou (CN); Ying ZHANG, Hangzhou (CN)

(21) Appl. No.: 17/445,218

(22) Filed: Aug. 17, 2021

(30) Foreign Application Priority Data
Apr. 15, 2021 (CN) 202110403274.5

(51) Int. Cl. G06F 16/901; G06F 16/903; G06F 16/9035

(52) U.S. Cl. CPC G06F 16/9024; G06F 16/90344; G06F 16/9035

(57) ABSTRACT

The present disclosure relates to a full-text indexing method and system based on a graph database. A full-text indexing engine creates an index template, data with a field type being character string in a graph database is synchronized to the full-text indexing engine, the full-text indexing engine creates an index for each piece of character string data according to the index template to obtain a full-text index; the graph database acquires and sends query request information to the full-text indexing engine; the full-text indexing engine acquires a first result set of a query statement according to the full-text index; the graph database performs data scanning on the first result set based on key-value pairs to obtain a second result set. The full-text indexing engine supports conditional filtering of the character string type. Character string data is quickly found in the full-text indexing engine, thereby improving efficiency of data retrieval.

### CROSS REFERENCE TO RELATED APPLICATION(S)

This patent application claims the benefit and priority of Chinese Patent Application No. 202110403274.5 filed on Apr. 15, 2021, the disclosure of which is incorporated by reference herein in its entirety as part of the present application.

### TECHNICAL FIELD

The present disclosure relates to the technical field of computers, and in particular, to a full-text indexing method and system based on a graph database.

### BACKGROUND

With the emergence of retail, finance, e-commerce, Internet, Internet of Things and other industries, the volume of basic data is growing exponentially. It is difficult to organize the growing huge amount of data into a relational network by using a traditional relational database. As a result, a number of databases specialized in storing and computing relational network data have emerged in the industry, which are known as graph databases. The retrieval efficiency in the massive relational data is an issue that every graph database needs to address, and the implementation of graph database indexing effectively improves the data retrieval efficiency.

In the related technology, representative graph databases include Nebula Graph, Neo4j and JanusGraph, etc. Nebula Graph is a high-performance graph database that can handle massive graph data with hundreds of billions of nodes and trillions of edges, while solving the problems of massive data storage and distributed parallel computing. However, the native key-value pair-based indexing of Nebula Graph can no longer meet the high performance requirements, and the index queries are inefficient; moreover, the queries generate high unnecessary network overheads.

No effective solution has been proposed to solve the problems of low index query efficiency of Nebula Graph and high unnecessary network overheads generated by queries in the related technology.

### SUMMARY OF THE APPLICATION

Embodiments of the present disclosure provide a full-text indexing method and system based on a graph database, to at least solve the problems of low index query efficiency of Nebula Graph and high unnecessary network overheads generated by queries in the related technology.

According to a first aspect, the embodiments of the present disclosure provide a full-text indexing method based on a graph database, including:

creating an index template in a full-text indexing engine, synchronizing data with a field type being character string in a graph database to the full-text indexing engine, and creating, by the full-text indexing engine, an index for each piece of character string data according to the index template to obtain a full-text index; and

acquiring, by the graph database, query request information, and sending the query request information to the full-text indexing engine; acquiring, by the full-text indexing engine, a first result set of a query statement according to the full-text index; and performing, by the graph database, data scanning on the first result set based on key-value pairs to obtain a second result set, wherein the query request information includes the query statement.

In some embodiments, before acquiring, by the graph database, query request information, and sending the query request information to the full-text indexing engine, the method further includes:

determining, by the graph database, whether the query request information includes conditional filtering;

sending, by the graph database, the query request information to the full-text indexing engine if a determining result is yes; and

performing, by the graph database, index scanning according to the query request information to obtain a third result set if the determining result is no.

In some embodiments, performing, by the graph database, index scanning according to the query request information to obtain a third result set includes:

acquiring, by the graph database, a point index or an edge index in the query request information, and scanning a target graph partition according to the point index or the edge index to obtain the third result set, wherein the query statement includes the point index or the edge index.

In some embodiments, before performing, by the graph database, index scanning according to the query request information, the method further includes:

acquiring, by the graph database, a write request of a point or an edge, then performing a hash operation according to a point ID of the point or an edge ID of the edge, and storing the point or the edge into the target graph partition according to a hash operation result, wherein the point includes the point ID and an attribute value of the point, and the edge includes the edge ID and an attribute value of the edge; and

creating, by the graph server, a point index according to the attribute value of the point, creating an edge index according to the attribute value of the edge, storing the point index into the target graph partition in which the corresponding point is located, and storing the edge index into the target graph partition in which the corresponding edge is located.

In some embodiments, after performing, by the graph database, data scanning on the first result set based on key-value pairs to obtain a second result set-, the method further includes:

determining, by the graph database, whether the query request information includes an expression filter statement, and if a determining result is yes, performing, by the graph database, expression filtering on the second result set according to the expression filter statement to obtain a target result; and

using the second result set as a final target result if the determining result is no.

According to a second aspect, the embodiments of the present disclosure provide a full-text indexing system based on a graph database, wherein the system includes a client, a graph database, and a full-text indexing engine, and the graph database includes a graph server, a metadata server, and a storage server;

the metadata server is configured to store connection information and metadata information of the full-text indexing engine;

the client is configured to send query request information to the graph server, wherein the query request information includes a query statement;

the graph server is configured to acquire the query request information sent by the client, and send the query request information to the full-text indexing engine;

the full-text indexing engine is configured to acquire a first result set of the query statement according to a full-text index and return the first result set to the graph server, wherein an index template is created in the full-text indexing engine in advance, data with a field type being character string in the graph database is synchronized to the full-text indexing engine, and the full-text indexing engine creates an index for each piece of character string data according to the index template to obtain the full-text index; and

the storage server is configured to acquire the first result set from the graph server, perform data scanning on the first result set based on key-value pairs to obtain a second result set, and return the second result set to the client through the graph server.

In some embodiments, before the graph server sends the query request information to the full-text indexing engine,

the graph server determines whether the query request information includes conditional filtering;

the graph server sends the query request information to the full-text indexing engine if a determining result is yes; and

the graph server sends the query request information to the storage server if the determining result is no, the storage server performs index scanning according to the query request information to obtain a third result set and returns the third result set to the client through the graph server.

In some embodiments, the storage server performing the index scanning according to the query request information to obtain the third result set includes:

the storage server acquires a point index or an edge index in the query request information, and scans a target graph partition according to the point index or the edge index to obtain the third result set, wherein the query statement includes the point index or the edge index.

In some embodiments, before the storage server performs the index scanning according to the query request information,

the graph server acquires a write request of a point or an edge, then performs a hash operation according to a point ID of the point or an edge ID of the edge, and stores the point or the edge into the target graph partition according to a hash operation result, wherein the point includes the point ID and an attribute value of the point, and the edge includes the edge ID and an attribute value of the edge; and

the graph server creates a point index according to the attribute value of the point, creates an edge index according to the attribute value of the edge, stores the point index into the target graph partition in which the corresponding point is located, and stores the edge index into the target graph partition in which the corresponding edge is located.

In some embodiments, after the storage server performs the data scanning on the first result set based on the key-value pairs to obtain the second result set,

the graph server determines whether the query request information includes an expression filter statement, and if a determining result is yes, the storage server performs expression filtering on the second result set according to the expression filter statement to obtain a target result and returns the target result to the client through the graph server; and

the storage server uses the second result set as a final target result and returns the target result to the client through the graph server if the determining result is no.

Compared with the related technology, in the full-text indexing method based on a graph database provided in the embodiments of the present disclosure, an index template is created in a full-text indexing engine, data with a field type being character string in a graph database is synchronized to the full-text indexing engine, and the full-text indexing engine creates an index for each piece of character string data according to the index template to obtain a full-text index; the graph database acquires query request information, and sends the query request information to the full-text indexing engine; the full-text indexing engine acquires a first result set of a query statement according to the full-text index; and the graph database performs data scanning on the first result set based on key-value pairs to obtain a second result set, wherein the query request information includes the query statement. The full-text indexing engine supports conditional filtering of the character string type. Therefore, the index template is created in the full-text indexing engine first, and when the data with the field type being character string in the graph database is synchronized to the full-text indexing engine, a full-text index will be automatically created according to the index template. Character string data is quickly found in the full-text indexing engine first, and then the graph database performs data scanning on the character string data based on key-value pairs, to obtain a plurality of attribute values corresponding to the character string data, thereby improving the efficiency of data retrieval and reducing high network overheads caused by random queries.

### BRIEF DESCRIPTION OF DRAWINGS

The accompanying drawings described here are provided for further understanding of the present disclosure, and constitute a part of the present disclosure. The exemplary embodiments and illustrations of the present disclosure are intended to explain the present disclosure, but do not constitute inappropriate limitations to the present disclosure. In the drawings:

FIG. 1 is a structural block diagram of a full-text indexing system based on a graph database according to an embodiment of the present disclosure;

FIG. 2 is a schematic diagram of a distributed architecture of a full-text indexing system based on a graph database according to an embodiment of the according present disclosure; and

FIG. 3 is a flowchart of a full-text indexing method based on a graph database according to an embodiment of the present disclosure.

### DETAILED DESCRIPTION

To make the objectives, technical solutions, and advantages of the present disclosure clearer, the present disclosure is described below with reference to the accompanying drawings and embodiments. It should be understood that the embodiments described herein are merely used to explain the present disclosure, rather than to limit the present disclosure. All other embodiments obtained by those of ordinary skill in the art based on the embodiments of the present disclosure without creative efforts should fall within the protection scope of the present disclosure. In addition, it can also be appreciated that, although it may take enduring and complex efforts to achieve such a development process, for those of ordinary skill in the art related to the present disclosure, some changes such as design, manufacturing or production made based on the technical content in the present disclosure are merely regular technical means, and should not be construed as insufficiency of the present disclosure.

The “embodiment” mentioned in the present disclosure means that a specific feature, structure, or characteristic described in combination with the embodiment may be included in at least one embodiment of the present disclosure. The phrase appearing in different parts of the specification does not necessarily refer to the same embodiment or an independent or alternative embodiment exclusive of other embodiments. It may be explicitly or implicitly appreciated by those of ordinary skill in the art that the embodiment described herein may be combined with other embodiments as long as no conflict occurs.

Unless otherwise defined, the technical or scientific terms used in the present disclosure are as they are usually understood by those of ordinary skill in the art to which the present disclosure pertains. The terms “one”, “a”, “the” and similar words are not meant to be limiting, and may represent a singular form or a plural form. The terms “include”, “contain”, “have” and any other variants in the present disclosure mean to cover the non-exclusive inclusion, for example, a process, method, system, product, or device that includes a series of steps or modules (units) is not necessarily limited to those steps or units which are clearly listed, but may include other steps or units which are not expressly listed or inherent to such a process, method, system, product, or device. “Connected”, “interconnected”, “coupled” and similar words in the present disclosure are not restricted to physical or mechanical connections, but may include electrical connections, whether direct or indirect. The term “multiple” in the present disclosure means two or more. The term “and/or” describes associations between associated objects, and it indicates three types of relationships. For example, “A and/or B” may indicate that A exists alone, A and B coexist, or B exists alone. The terms “first”, “second”, “third” and so on in the present disclosure are intended to distinguish between similar objects but do not necessarily indicate a specific order of the objects.

This embodiment provides a full-text indexing system based on a graph database, for implementing the embodiments and preferred implementation manners of the present disclosure, which have been illustrated and are not described again. As used below, the terms “module”, “unit”, and “subunit” and the like may implement the combination of software and/or hardware having predetermined functions. Although the apparatus described in the following embodiments is preferably implemented by software, implementation by hardware or the combination of the software and the hardware is also possible and may be conceived.

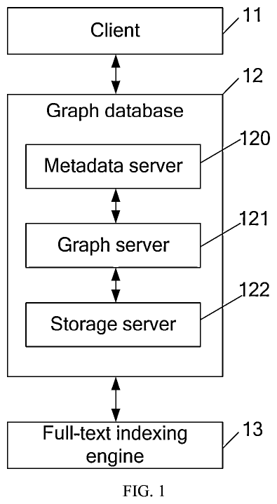

FIG. 1 is a structural block diagram of a full-text indexing system based on a graph database according to an embodiment of the present disclosure. As shown in FIG. 1, the system includes a client 11, a graph database 12, and a full-text indexing engine 13. The graph database 12 includes a graph server 121, a metadata server 120, and a storage server 122. The metadata server 120 stores connection information and metadata information of the full-text indexing engine 13 (Elasticsearch, ES for short). After the ES is installed successfully, connection information of a full-text indexing engine cluster needs to be registered and stored in the metadata server 120. Nodes of the ES are point-to-point, and any point provides a service. Therefore, when the metadata server 120 connects the full-text indexing engine 13, it is necessary to monitor whether the client 11 is normal at a regular time, and perform load balancing. The metadata server 120 further provides a function for modifying information of the full-text indexing engine cluster. If the full-text indexing engine cluster of the user is abnormal, the user can choose to switch to another cluster.

The client 11 sends query request information to the graph server 121, wherein the query request information includes a query statement. After acquiring the query request information sent by the client 11, the graph server 121 sends the query request information to the full-text indexing engine 13. In this embodiment, the query request information includes an expression of a full-text index. The graph server 121 converts the expression of the full-text index to an operator of the full-text index according to syntax parsing, and then sends the operator of the full-text index to the full-text indexing engine 13. For example, the expression of the full-text index is “LOOKUP ON player WHERE PREFIX (player.name, “B”) YIELD player.age”, and after the keywords player, name, and “B” are obtained through syntax parsing, the operator of the full-text index, that is, the query structure, is generated according to the keywords, wherein the query structure includes all information elements required for the current query. The graph server 121 translates the query structure into a query statement compatible with the ES.

The full-text indexing engine 13 acquires a first result set of the query statement according to the full-text index, and returns the first result set to the graph server 121, wherein an index template is created in the full-text indexing engine 13 in advance, and data with a field type being character string in the graph database 12 is synchronized to the full-text indexing engine 13. The full-text indexing engine 13 creates an index for each piece of character string data according to the index template to obtain a full-text index. The full-text indexing engine 13 supports conditional filtering of the character string type, for example, fuzzy matching, prefix matching, wildcard matching, and regular expression matching. Through the conditional filtering for the character string type, the retrieval efficiency can be improved. Therefore, the data with the field type being character string in the graph database 12 is synchronized to the full-text indexing engine 13, and the full-text index is created, according to the index template, for the character string data synchronized to the full-text indexing engine 13. Character string data meeting the query statement can be quickly retrieved according to the full-text index, thereby improving the data retrieval efficiency.

The storage server 122 is configured to acquire the first result set from the graph server 121, perform data scanning on the first result set based on key-value pairs to obtain a second result set, and return the second result set to the client 11 through the graph server 121. For example, players whose names begin with the letter B are queried through prefix matching. The expression of the full-text index is “LOOKUP ON player WHERE PREFIX (player.name, “B”) YIELD player.age”. The first result set retrieved from the full-text indexing engine 13 is “Boris Diaw”, “Ben Simmons”, and “Blake Griffin”, and the storage server 122 performs data scanning on the first result set based on key-value pairs, and queries attribute values corresponding to the three nodes in the first result set to obtain the second result set. For example, attribute values corresponding to Boris Diaw include as nationality, gender and age, etc. The second result set is returned to the client 11 via the graph server 121.

An index template is created in the full-text indexing engine 13 in advance, and data with the field type being character string in the graph database 12 is synchronized to the full-text indexing engine 13. The full-text indexing engine 13 creates an index for each piece of character string data according to the index template to obtain a full-text index. The full-text indexing engine 13 supports conditional filtering of the character string type, and can quickly retrieve character string data that matches the query statement and then perform data scanning on the retrieved character string data based on key-value pairs to obtain a more accurate result. The present disclosure solves the problem of low efficiency of queries based on the native key-value pair indexing of the graph database 12 (Neula Graph) and high unnecessary network overheads generated by the queries in the related technology, and improves the retrieval efficiency.

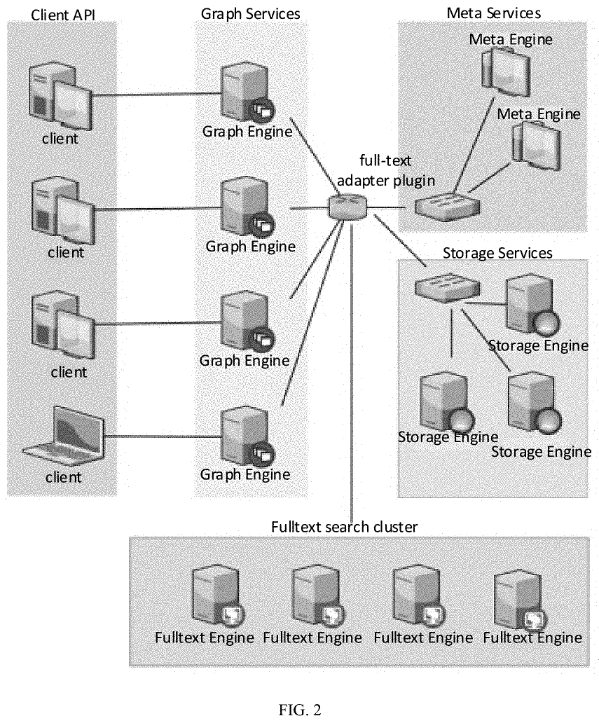

In some embodiments, FIG. 2 is a schematic diagram of a distributed architecture of a full-text indexing system based on a graph database according to an embodiment of the according present disclosure. As shown in FIG. 2, a full-text indexing engine cluster (Fulltext search cluster) is independent of the architecture of the graph database 12 (Neula Graph) and communicates the metadata server 120 (Metad services), the graph server 121 (graphd services) and the storage server 122 (storage services) through a full-text adapter plugin. The graph server 121, metadata server 120, and storage server 122 can all be deployed in a distributed manner. The user can configure the full-text indexing search engine completely independently, e.g., it is entirely up to the user to decide the number of nodes and the specific nodes for configuration, and the user only needs to provide corresponding connection information for a full-text client plugin.

The metadata server 120 adopts a leader/follower architecture. The leader is selected by all the metadata server nodes in the metadata server cluster and provides a service to the external. The followers are in a standby state and replicate updated data from the leader. Once the leader node stops providing the service, one of the followers is elected as the new leader. The graph server 121 includes a computing layer. Each computing node runs a stateless query computing engine, and each computing node does not have any communication with each other. The computing nodes only read metadata information from the metadata server 120 and interact with the storage server 122. The storage server 122 is designed with a shared-nothing distributed architecture. Each storage server node has multiple local key-value pair store instances as physical storage. Nebula Graph uses the quorum protocol Raft to ensure consistency among the key-value pair stores. The graph data (points and edges) are stored in different graph partitions by means of hashing, and the graph partition represents a virtual dataset. The graph partitions are distributed over all storage nodes, and the distribution information is stored in the metadata server 120. Therefore, all the storage nodes and computing nodes have access to the distribution information.

In some embodiments, before the graph server 121 sends the query request information to the full-text indexing engine 13, the graph server 121 determines whether the query request information contains conditional filtering; if the determining result is yes, the graph server 121 sends the query request information to the full-text indexing engine 13; if the determining result is no, the graph server 121 sends the query request information to the storage server 122. The storage server 122 performs index scanning according to the query request information to obtain the third result set and returns the third result set to the client 11 through the graph server 121. In this embodiment, the conditional filtering of the character string type includes fuzzy matching (FUZZY), prefix matching (PREFIX) and wildcard matching (WILDCARD), etc. If the query request information contains FUZZY, PREFIX or WILDCARD, etc., it is determined that the query request information contains conditional filtering, and the query request information is sent to the full-text indexing engine 13. If the query request information does not contain the conditional filtering, it indicates that the query request information does not require full-text indexing, and in this case, the query request information is sent to the storage server 122. Index scanning is performed in the storage server 122, and the third result set obtained according to the index scanning is returned to the client 11 through the graph server 121.

In some embodiments, the storage server 122 performing the index scanning according to the query request information to obtain the third result set includes:

the storage server 122 acquires a point index or an edge index in the query request information, and scans a target graph partition according to the point index or the edge index to obtain the third result set, wherein the query statement includes the point index or the edge index. In this embodiment, according to the point index or the edge index, the graph partition where the point index or the edge index is located can be obtained, wherein the graph partition is a query range of the index scanning. The storage server 122 has multiple graph partitions. If multiple point indexes or multiple edge indexes need to be queried at the same time, the graph partitions where the point indexes or edge indexes are located are obtained at the same time, and concurrent queries are performed on the multiple graph partitions at the same time. Multiple query results are returned to the graph server 121 uniformly. The graph server 121 aggregates the results to obtain a result set and returns the result set to the client 11. By defining the query range of the index scanning and performing concurrent queries, high network overheads caused by random queries can be reduced and the retrieval efficiency is improved.

In some embodiments, before the storage server 122 performs index scanning based on the query request information, the graph server 121 obtains a write request of a point or an edge, then performs a hash operation according to a point ID of the point or an edge ID of the edge, and stores the point or the edge into a target graph partition according to a hash operation result, wherein the point includes the point ID and an attribute value of the point, and the edge includes the edge ID and an attribute value of the edge. The graph server 121 creates a point index according to the attribute value of the point, creates an edge index based on the attribute value of the edge, stores the point index into the target graph partition where the corresponding point is located, and stores the edge index into the target graph partition where the corresponding edge is located. In this embodiment, the point index or the edge index includes a graph partition ID, an index ID and an attribute. The graph partition ID indicates the graph partition where the point or the edge is located, the index ID is used to distinguish different index items of the point or the edge, and the attribute is a stored point or edge attribute value. By creating an index for the point or the edge, the query range of the index scanning can be narrowed down and the query efficiency can be improved.

In some embodiments, after the storage server 122 performs data scanning on the first result set based on key-value pairs to obtain the second result set, the graph server 121 determines whether the query request information includes an expression filtering statement. If the determining result is yes, the storage server 122 performs expression filtering on the second result set to obtain a target result according to the expression filtering statement and returns the target result to the client 11 through the graph server 121. If the determining result is no, the second result set is used as the final target result and the target result is returned to the client 11 through the graph server 121. For example, if the query statement is lookup on player where player.name=“B” AND player.age >1, the storage server 122 will first perform scanning to obtain all result sets that match the condition player.name=“B”, and then filter all the result sets again by using the expression filter statement player.age >1 to obtain the target result.

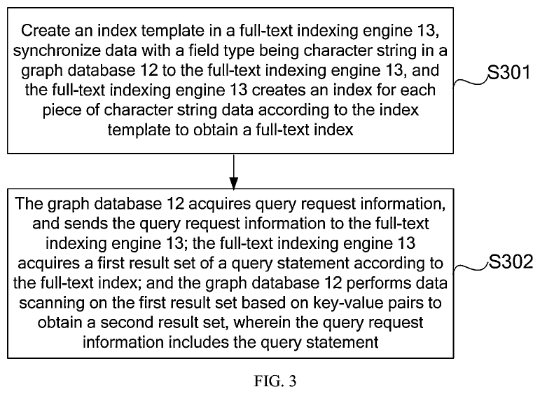

This embodiment provides a full-text indexing method based on a graph database. FIG. 3 is a flowchart of a full-text indexing method based on a graph database according to an embodiment of the present disclosure. As shown in FIG. 3, the method includes the following steps:

Step S301: Create an index template in a full-text indexing engine 13, synchronize data with a field type being character string in a graph database 12 to the full-text indexing engine 13, and the full-text indexing engine 13 creates an index for each piece of character string data according to the index template to obtain a full-text index.

Step S302: The graph database 12 acquires query request information, and sends the query request information to the full-text indexing engine 13; the full-text indexing engine 13 acquires a first result set of a query statement according to the full-text index; and the graph database 12 performs data scanning on the first result set based on key-value pairs to obtain a second result set, wherein the query request information includes the query statement.

In the related technology, graph computing generally requires a large amount of conditional filtering of the character string type, such as fuzzy matching, prefix matching, wildcard matching, and regular expression matching of the character string type. At this point, the native key-value pair-based indexing of the graph database 12 is no longer sufficient to achieve high performance. Through the above steps S301 to S302, an index template is created in the full-text indexing engine 13 in advance, and a full-text index is automatically created based on the index template when data with the field type being character string in the graph database 12 is synchronized to the full-text indexing engine 13, and the full-text indexing engine 13 supports search methods such as fuzzy matching, prefix matching, wildcard matching and regular expression matching. Character string data is quickly found in the full-text indexing engine 13 first, and the graph database 12 then performs data scanning on the character string data based on key-value pairs to obtain multiple attribute values corresponding to the character string data, thereby improving the efficiency of data retrieval.

It should be noted that, steps shown in the foregoing process or the flowchart in the accompanying drawings may be executed in a computer system such as a set of computer executable instructions. Moreover, although a logic sequence is shown in the flowchart, the shown or described steps may be executed in a sequence different from that described here.

This embodiment further provides an electronic device, including a memory and a processor. The memory stores a computer program, and the processor is configured to perform the steps in any of the method embodiments above by running the computer program.

It should be noted that, for the specific example in this embodiment, reference may be made to the example described in the embodiments and optional implementation manners described above. Details are not described herein again.

In addition, an embodiment of the present disclosure can provide a storage medium to implement the full-text indexing method based on a graph database in the foregoing embodiments. The storage medium stores a computer program. When the computer program is executed by a processor, any full-text indexing method based on a graph database in the foregoing embodiments is implemented.

In an embodiment, a computer device is provided. The computer device may be a terminal. The computer device includes a processor, a memory, a network interface, a display, and an input apparatus which are connected through a system bus. The processor of the computer device is configured to provide computing and control capabilities. The memory of the computer device includes a nonvolatile storage medium and an internal memory. The nonvolatile storage medium stores an operating system and a computer program. The internal memory provides an environment for operations of the operating system and the computer program in the nonvolatile storage medium. The network interface of the computer device is configured to communicate with an external terminal through a network. When the computer program is executed by the processor, a full-text indexing method based on a graph database is implemented. The display of the computer device may be an LCD or an e-ink display; the input apparatus of the computer device may be a touch layer covering the display, or a key, a trackball or a touchpad set on the housing of the computer device, or an external keyboard, a touchpad or a mouse, etc.

Those of ordinary skill in the art may understand that all or some of the procedures in the methods of the foregoing embodiments may be implemented by a computer program instructing related hardware. The computer program may be stored in a nonvolatile computer readable storage medium. When the computer program is executed, the procedures in the embodiments of the foregoing methods may be performed. For any reference used for a memory, a storage, a database, or other mediums used in various examples provided in this application may include a nonvolatile memory and/or a volatile memory. The nonvolatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. As description rather than limitation, the RAM can be obtained in a plurality of forms, such as a static RAM (SRAM), a dynamic RAM (DRAM), a synchronous DRAM (SDRAM), a double data rate SDRAM (DDRSDRAM), an enhanced SDRAM (ESDRAM), a synchronization link (Synchlink) DRAM (SLDRAM), a Rambus direct RAM (RDRAM), a direct Rambus dynamic RAM (DRDRAM), and a Rambus dynamic RAM (RDRAM).

Those skilled in the art should understand that, the technical features of the above embodiments can be arbitrarily combined. In an effort to provide a concise description, not all possible combinations of all the technical features of the embodiments are described. However, these combinations of technical features should be construed as disclosed in the description as long as no contradiction occurs.

The above embodiments are merely illustrative of several implementation manners of the present disclosure, and the description thereof is more specific and detailed, but is not to be construed as a limitation to the patentable scope of the present disclosure. It should be pointed out that several variations and improvements can be made by those of ordinary skill in the art without departing from the conception of the present disclosure, but such variations and improvements should fall within the protection scope of the present disclosure. Therefore, the protection scope of the patent of the present disclosure should be subject to the appended claims.

What is claimed is:

1. A full-text indexing method based on a graph database, comprising:
creating an index template in a full-text indexing engine, synchronizing data with a field type being character string in a graph database to the full-text indexing engine, and creating, by the full-text indexing engine, an index for each piece of character string data according to the index template to obtain a full-text index; and
acquiring, by the graph database, query request information, and sending the query request information to the full-text indexing engine; acquiring, by the full-text indexing engine, a first result set of a query statement according to the full-text index; and performing, by the graph database, data scanning on the first result set based on key-value pairs to obtain a second result set, wherein the query request information comprises the query statement.

2. The method according to claim 1, wherein before acquiring, by the graph database, query request information, and sending the query request information to the full-text indexing engine, the method further comprises:
determining, by the graph database, whether the query request information comprises conditional filtering;
sending, by the graph database, the query request information to the full-text indexing engine if a determining result is yes; and
performing, by the graph database, index scanning according to the query request information to obtain a third result set if the determining result is no.

3. The method according to claim 2, wherein performing, by the graph database, index scanning according to the query request information to obtain a third result set comprises:
acquiring, by the graph database, a point index or an edge index in the query request information, and scanning a target graph partition according to the point index or the edge index to obtain the third result set, wherein the query statement comprises the point index or the edge index.

4. The method according to claim 3, wherein before performing, by the graph database, index scanning according to the query request information, the method further comprises:
acquiring, by the graph database, a write request of a point or an edge, then performing a hash operation according to a point ID of the point or an edge ID of the edge, and storing the point or the edge into the target graph partition according to a hash operation result, wherein the point comprises the point ID and an attribute value of the point, and the edge comprises the edge ID and an attribute value of the edge; and
creating a point index according to the attribute value of the point, creating an edge index according to the attribute value of the edge, storing the point index into the target graph partition in which the corresponding point is located, and storing the edge index into the target graph partition in which the corresponding edge is located.

5. The method according to claim 1, wherein after performing, by the graph database, data scanning on the first result set based on key-value pairs to obtain a second result set, the method further comprises:
determining, by the graph database, whether the query request information comprises an expression filter statement, and if a determining result is yes, performing, by the graph database, expression filtering on the second result set according to the expression filter statement to obtain a target result; and
using the second result set as a final target result if the determining result is no.

6. A full-text indexing system based on a graph database, comprising a client, a graph database, and a full-text indexing engine, and the graph database comprises a graph server, a metadata server, and a storage server;
the metadata server is configured to store connection information and metadata information of the full-text indexing engine;
the client is configured to send query request information to the graph server, wherein the query request information comprises a query statement;
the graph server is configured to acquire the query request information sent by the client, and send the query request information to the full-text indexing engine;
the full-text indexing engine is configured to acquire a first result set of the query statement according to a full-text index and return the first result set to the graph server, wherein an index template is created in the full-text indexing engine in advance, data with a field type being character string in the graph database is synchronized to the full-text indexing engine, and the full-text indexing engine creates an index for each piece of character string data according to the index template to obtain the full-text index; and
the storage server is configured to acquire the first result set from the graph server, perform data scanning on the first result set based on key-value pairs to obtain a second result set, and return the second result set to the client through the graph server.

7. The system according to claim 6, wherein before the graph server sends the query request information to the full-text indexing engine,
the graph server determines whether the query request information comprises conditional filtering;
the graph server sends the query request information to the full-text indexing engine if a determining result is yes; and
the graph server sends the query request information to the storage server if the determining result is no, the storage server performs index scanning according to the query request information to obtain a third result set and returns the third result set to the client through the graph server.

8. The system according to claim 7, wherein the storage server performing the index scanning according to the query request information to obtain the third result set comprises:
the storage server acquires a point index or an edge index in the query request information, and scans a target graph partition according to the point index or the edge index to obtain the third result set, wherein the query statement comprises the point index or the edge index.

9. The system according to claim 8, wherein before the storage server performs the index scanning according to the query request information,
the graph server acquires a write request of a point or an edge, then performs a hash operation according to a point ID of the point or an edge ID of the edge, and stores the point or the edge into the target graph partition according to a hash operation result, wherein the point comprises the point ID and an attribute value of the point, and the edge comprises the edge ID and an attribute value of the edge; and
the graph server creates a point index according to the attribute value of the point, creates an edge index according to the attribute value of the edge, stores the point index into the target graph partition in which the corresponding point is located, and stores the edge index into the target graph partition in which the corresponding edge is located.

10. The system according to claim 6, wherein after the storage server performs the data scanning on the first result set based on the key-value pairs to obtain the second result set,
the graph server determines whether the query request information comprises an expression filter statement, and if a determining result is yes, the storage server performs expression filtering on the second result set according to the expression filter statement to obtain a target result and returns the target result to the client through the graph server; and
the storage server uses the second result set as a final target result and returns the target result to the client through the graph server if the determining result is no.
